(19) United States
(12) Patent Application Publication
(10) Pub. No.: US 2011/0176842 A1
(43) Pub. Date: Jul. 21, 2011

(54) IMAGE FORMING APPARATUS, CONTROL METHOD THEREOF, AND STORAGE MEDIUM

(75) Inventor: Hitoshi Fukamachi, Kawasaki-shi (JP)

(73) Assignee: CANON KABUSHIKI KAISHA, Tokyo (JP)

(21) Appl. No.: 12/969,297

(22) Filed: Dec. 15, 2010

(30) Foreign Application Priority Data
Jan. 20, 2010 (JP) 2010-010368
Oct. 21, 2010 (JP) 2010-236846

(51) Int. Cl. G03G 15/01

(52) U.S. Cl. 399/301

(57) ABSTRACT

An image forming apparatus which forms an output image using a transparent colorant and a colored colorant, the apparatus comprises: a formation unit configured to form an adjustment pattern image using the transparent colorant and the colored colorant; an acquisition unit configured to acquire a density value in the formed pattern image; and a calculation unit configured to calculate, based on the acquired density value, a misalignment amount of the transparent colorant with respect to the colored colorant, wherein in the formed pattern image, the area with the transparent colorant are repetitively arranged at first intervals, and the area with the colored colorant are repetitively arranged at second intervals.

### BACKGROUND OF THE INVENTION

1. Field of the Invention

The present invention relates to an image forming apparatus that forms a color image using colorants of a plurality of colors including a transparent colorant, and a control method thereof.

2. Description of the Related Art

Various methods have conventionally been proposed for an image forming apparatus that forms image on a printing medium. A typical example is an electrophotographic printing apparatus. In the electrophotographic printing apparatus, a photosensitive member serving as an image carrier is charged by a charger, and irradiated with light in accordance with image information to form a latent image. Development processing is performed to apply a colorant (toner or ink) to the latent image, and the applied colorant is transferred to a sheet-like printing medium such as paper. An image is formed by the series of processes.

A so-called tandem type color image forming apparatus has been proposed for a color image. For each color, this apparatus includes an image forming unit which executes the above-described image forming processes. Respective color images are formed on corresponding image carriers, and transferred to an intermediate transfer member at the transfer positions of the respective image carriers to overlap each other. The respective color images are transferred again to a printing medium, forming a full-color image.

However, in the tandem type color image forming apparatus, color misalignment sometimes arises from misalignment of the formation positions of respective images formed by different image forming units. This may result in image degradation such as color shift on an image. To prevent this, a technique of detecting color misalignment by a density sensor or the like and correcting it has been proposed.

For example, there is proposed a technique of printing color detection reference images as toner images, measuring them by a density sensor to calculate the amount of misalignment between respective colors (color misalignment detection), and aligning the respective images in accordance with the misalignment amount (color misalignment correction) (see, for example, Japanese Patent Laid-Open No. 06-051607).

Recent color image forming apparatuses are beginning to use a colorless transparent colorant (to be referred to as a transparent colorant) such as clear toner or clear ink, in addition to conventionally used colored colorants such as cyan, magenta, yellow, and black colorants. The transparent colorant is mainly used in value-added printing for implementing high gloss reproduction, texture, watermark, decorative effect (metallic color), and the like. As for the transparent colorant, as well as the colored colorant, color misalignment needs to be corrected.

To detect color misalignment of the transparent colorant, there is proposed a technique of measuring the surface roughness on a printing medium to detect the recorded position of a transparent colorant, and correcting color misalignment (see, for example, Japanese Patent Laid-Open No. 2008-143044). There is also proposed a technique of illuminating an area containing the recorded position of a transparent colorant, measuring the regularly reflected light quantity to detect the recorded position of the transparent colorant, and correcting color misalignment (see, for example, Japanese Patent Laid-Open No. 2003-159783).

However, the color misalignment correction technique as disclosed in Japanese Patent Laid-Open No. 06-051607 is effective for a colored colorant, but is not effective for a transparent colorant because no density can be detected by a density sensor or the like, and a toner image is neither detected nor corrected.

The color misalignment correction technique as disclosed in Japanese Patent Laid-Open No. 2008-143044 requires a high-precision surface shape measurement device to measure the surface roughness on a printing medium.

The color misalignment correction technique as disclosed in Japanese Patent Laid-Open No. 2003-159783 requires a special device for measuring the regularly reflected light quantity of a small area of a several ten micron square in order to detect the recorded position of a transparent colorant from the difference in glossiness.

### SUMMARY OF THE INVENTION

The present invention has been made to overcome the conventional drawbacks, and provides an image forming apparatus which implements the following functions, and a control method thereof. More specifically, the invention enables to easily detect color misalignment of a transparent colorant in an image forming apparatus which forms an output image by applying transparent and colored colorants to overlap each other.

According to one aspect of the invention, an image forming apparatus which forms an output image using a transparent colorant and a colored colorant comprises: a formation unit configured to form an adjustment pattern image using the transparent colorant and the colored colorant; an acquisition unit configured to acquire a density value in the formed pattern image; and a calculation unit configured to calculate, based on the acquired density value, a misalignment amount of the transparent colorant with respect to the colored colorant, wherein in the formed pattern image, the area with the transparent colorant are repetitively arranged at first intervals, and the area with the colored colorant are repetitively arranged at second intervals.

Further features of the present invention will become apparent from the following description of exemplary embodiments (with reference to the attached drawings).

### BRIEF DESCRIPTION OF THE DRAWINGS

FIG. 1 is a block diagram showing the system configuration of an image forming apparatus in the first embodiment;

FIG. 2 is a schematic view showing the detailed arrangement of an engine control unit in the first embodiment;

FIG. 3 is a flowchart showing registration adjustment processing in the first embodiment;

FIGS. 4A and 4B are views each exemplifying an adjustment pattern in the first embodiment;

FIG. 5 is a graph showing the density characteristic of the adjustment pattern in the first embodiment;

FIG. 6 is a block diagram showing the arrangement of a CCD image sensor in the first embodiment;

FIG. 7 is a flowchart showing registration error calculation processing in the first embodiment;

FIG. 8 is a graph showing the relationship between the relative position between two colors, and the density value in the first embodiment;

FIGS. 9A to 9C are views each exemplifying an adjustment pattern in the second embodiment;

FIG. 10 is a graph showing the first and second density distributions in the second embodiment;

FIG. 11 is a flowchart showing registration error calculation processing in the second embodiment;

FIGS. 12A to 12C are schematic views showing the detection position of the CCD image sensor in the first embodiment; and

FIG. 13 is a view for explaining a conventional registration adjustment operation.

### DESCRIPTION OF THE EMBODIMENTS

Preferred embodiments of the present invention will now be described with reference to the accompanying drawings. It is to be understood that the following embodiments are not intended to limit the claims of the present invention, and that not all combinations of features described in the embodiments are indispensable as the means to solve the problems in the present invention.

### First Embodiment

Apparatus Arrangement

The first embodiment will exemplify an electrophotographic image forming apparatus that forms an output image by printing an image of a transparent colorant (transparent toner) and an image of a colored colorant (for example, black toner) to overlap each other.

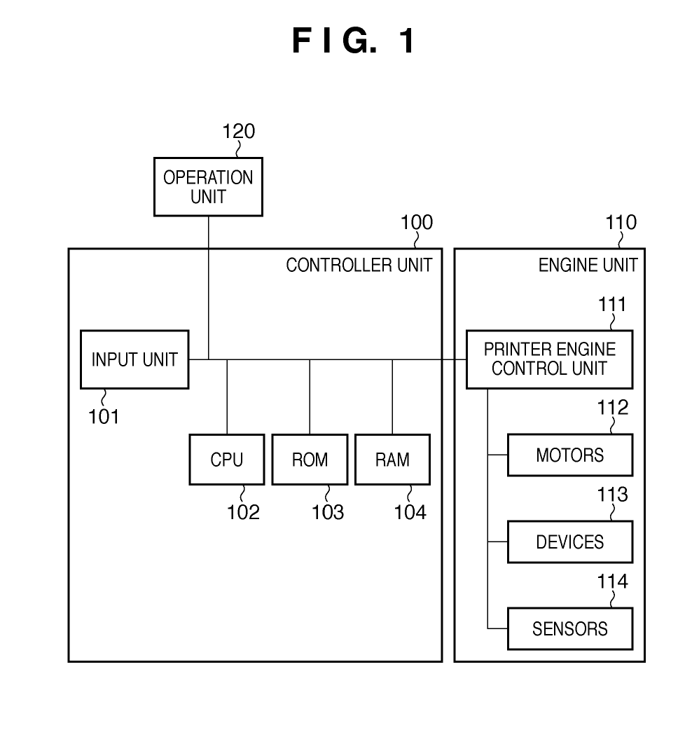

FIG. 1 is a block diagram showing the functional arrangement of the image forming apparatus according to the first embodiment. Referring to FIG. 1, a controller unit 100 includes a CPU 102 which controls the overall image forming apparatus, a ROM 103 in which a control program is written in advance, and a RAM 104 used as a work area for data during processing. Also, the controller unit 100 stores, in an input unit 101, image data input from a host apparatus (not shown) serving as an external apparatus, and transmits the image data to an engine unit 110. Further, the controller unit 100 transmits/receives control instructions and information.

The engine unit 110 includes a printer engine control unit 111, and the printer engine control unit 111 controls motors 112, devices 113, and sensors 114 in the printer engine of the embodiment. The motors 112 are, for example, motors used to drive an image carrier and printing paper-feeding system. The devices 113 are a laser scanner, photosensitive drum, printing paper-feeding system, developing device, fixing device, and the like. The sensors 114 are a CCD image sensor, density sensor, temperature sensor, humidity sensor, and the like. The printer engine control unit 111 controls the motors 112 and devices 113 in accordance with inputs from the controller unit 100 and information from the sensors 114.

An operation unit 120 has an interface with various resources such as a hard disk drive, computer, server, and network (none of them is shown). The operation unit 120 inputs printing image data from the resource to the controller unit 100.

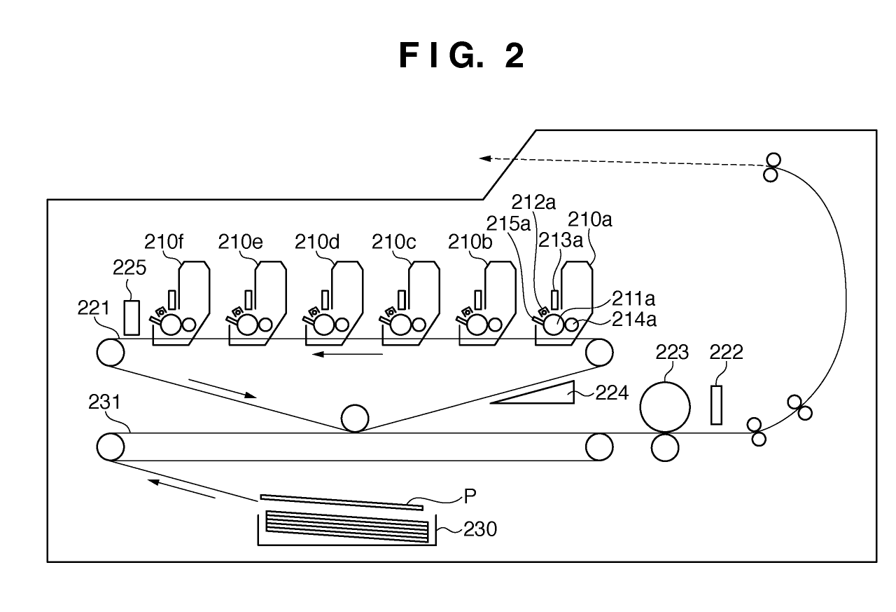

FIG. 2 is a sectional view schematically showing the arrangement of the engine unit 110. In the engine unit 110, a plurality of image forming units 210a to 210f are sequentially arranged on an intermediate transfer belt 221 in its moving direction (indicated by arrows in FIG. 2). Since the image forming units 210a to 210f have the same arrangement, the image forming unit 210a will be exemplified and its detailed arrangement will be explained. In the image forming unit 210a, a photosensitive drum 211a is axially supported at the center as an image carrier. A charger 212a, laser scanner 213a, developing unit 214a, and cleaning device 215a are arranged sequentially in the rotational direction of the photosensitive drum 211a to face the outer surface of the photosensitive drum 211a. All the image forming units 210a to 210f will be referred to as the image forming units 210. The image forming units 210a to 210f have the same internal arrangement. For example, photosensitive drums 211 mean photosensitive drums 211a to 211f in all the image forming units 210a to 210f. The engine unit 110 also includes a paper feed cassette 230, printing paper P, a paper conveyance belt 231, a fixing unit 223, a cleaning device 224 on the intermediate transfer belt 221, a density sensor 225, and a CCD image sensor 222.

An image forming operation in the engine unit 110 will be explained. First, the charger 212 applies a uniform amount of charges on the surface of the photosensitive drum 211. Then, the laser scanner 213 exposes the surface of the photosensitive drum 211 with a beam such as a semiconductor laser beam modulated in accordance with an image signal, forming an electrostatic latent image on the photosensitive drum 211. The electrostatic latent image is visualized as a toner image by each of the developing units 214 containing, for example, yellow, magenta, cyan, black, and spot color (for example, transparent, white, or corporate color) developers (to be referred to as toners). The toner image on the photosensitive drum 211 is primarily transferred onto the intermediate transfer belt 221. The printing paper P fed from the paper feed cassette 230 is conveyed on the paper conveyance belt 231, and the toner image on the intermediate transfer belt 221 is secondarily transferred onto the printing paper P. The fixing unit 223 fixes the toner image on the printing paper P by heat and pressure. The toner image-fixed printing paper P is discharged by discharge rollers to a discharge tray.

The engine unit 110 performs image formation by the above processes. The cleaning device 215 on the photosensitive drum 211, and the cleaning device 224 on the intermediate transfer belt 221 recover toner left on the photosensitive drum 211 and intermediate transfer belt 221. In the first embodiment, the engine unit 110 includes the density sensor 225 and CCD image sensor 222, and color misalignment is corrected based on their detection results. Details of this operation will be described later.

Conventional Registration Adjustment Processing

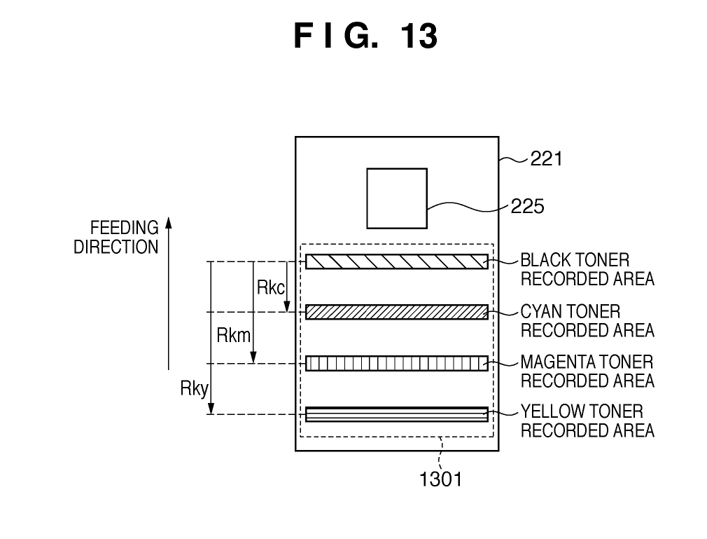

A typical example of conventional registration adjustment processing (to be simply referred to as registration adjustment) will be explained with reference to FIG. 13. In this example, four, C, M, Y, and K colored colorants undergo registration adjustment. FIG. 13 is a view for explaining a conventional registration adjustment operation in the image forming apparatus shown in FIG. 2. In this example, registration adjustment is done in the sub-scanning direction for printing paper. Note that registration adjustment can be executed at an arbitrary timing. For example, registration adjustment can be performed immediately after turning on the apparatus main body, after printing a predetermined number of sheets, or after the lapse of a predetermined time.

A registration adjustment pattern 1301 in which image patterns of the four colors are arranged at equal intervals, as shown in FIG. 13, is formed on the intermediate transfer belt 221. More specifically, the respective image forming units 210 form toner images of the respective colors in accordance with pattern data indicating the registration adjustment pattern 1301. The registration adjustment pattern 1301 is formed so that a black toner recorded area (K), cyan toner recorded area (C), magenta toner recorded area (M), and yellow toner recorded area (Y) are aligned in this order at predetermined intervals from the start in the conveyance direction of the intermediate transfer belt 221. The density sensor 225 detects toner densities in the registration adjustment pattern 1301, measuring a recording interval Rkc between K and C, a recording interval Rkm between K and M, and a recording interval Rky between K and Y using the black toner image at the start as a reference. In this way, the amount of registration error between colors is calculated.

The registration adjustment pattern 1301 is formed in accordance with printing data in which the recording intervals between K and C, between K and M, and between K and Y are set to SRkc, SRkm, and SRky. Differences between the recording intervals Rkc, Rkm, and Rky detected by the density sensor 225, and the recording intervals SRkc, SRkm, and SRky designated by the pattern data serve as registration error amounts. The difference between the recording intervals Rkc and SRkc, that between the recording intervals Rkm and SRkm, and that between the recording intervals Rky and SRky are defined as ΔRkc, ΔRkm, and ΔRky, respectively. The registrations of the respective colors are adjusted by electrically correcting the write timings of K, C, M, and Y image signals in accordance with the registration error amounts ΔRkc, ΔRkm, and ΔRky.

Registration adjustment in the sub-scanning direction has been exemplified. However, registration adjustment can be similarly done even in the main scanning direction. In this way, the registration errors between the four colored colorants are corrected. However, a simple measurement device such as a density sensor or CCD image sensor cannot read the density of the transparent colorant. It is therefore difficult to detect the toner image of the transparent toner and perform registration adjustment by the conventional method.

Registration Adjustment Processing

Registration adjustment processing for both the colored and transparent colorants in the above-described image forming apparatus according to the first embodiment will be explained. For descriptive convenience, the first embodiment will describe an example in which the amount of recorded position registration error between the dot pattern of the transparent toner and that of another color toner (for example, black toner) is detected and corrected.

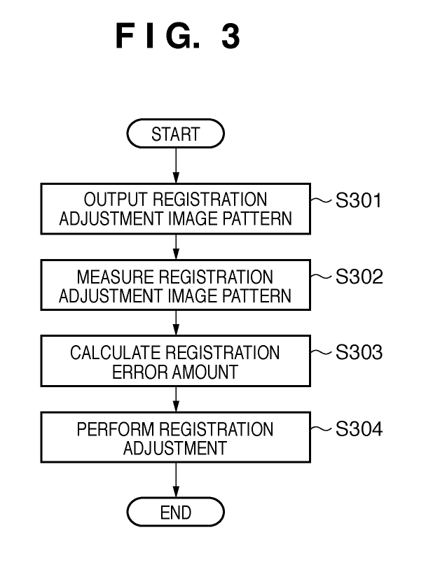

FIG. 3 is a flowchart showing an outline of registration adjustment processing in the first embodiment. In pattern formation step S301, the toner image (visual image) of a registration adjustment image pattern is formed on printing paper P serving as a printing medium by the foregoing image forming operation. Details of the registration adjustment image pattern will be described later. In density value acquisition step S302, the CCD image sensor 222 (to be described later) is used to measure the density value of the toner image of the registration adjustment image pattern formed in step S301 on the printing paper P. In misalignment amount calculation step S303, the registration error amount of the transparent toner is calculated based on the density value measured in step S302. The registration error amount calculation method will also be described later.

In recorded position adjustment step S304, so-called registration adjustment is performed by electrically adjusting the image write timing of each respective image forming unit 210 based on the amount of registration error between colors that has been calculated in step S303, so as to reduce the registration error amount. For example, the image write timing of the transparent toner is adjusted to coincide with that of the black toner. More specifically, the RAM 104 stores the image write timing of each image forming unit 210, and the controller unit 100 changes the image write timing in accordance with the amount of registration error between colors. This can electrically delay or advance the scan timing of the laser scanner 213, correcting the registration error between the image forming units 210.

Registration Adjustment Image Pattern Output Processing

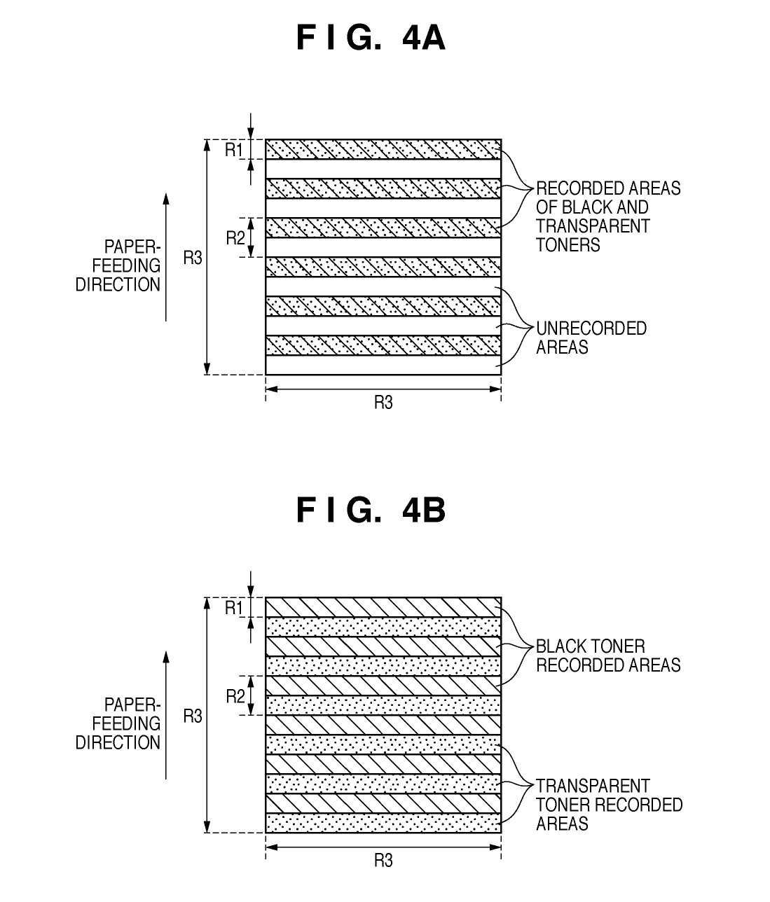

FIGS. 4A and 4B exemplify a registration adjustment pattern image (to be referred to as an adjustment pattern) output in the above-described registration adjustment image pattern output processing in step S301. In the patterns of FIGS. 4A and 4B, an image in which transparent toner recorded areas (width R1) are repetitively arranged at predetermined intervals R2, and an image in which black toner recorded areas (width R1) are repetitively arranged at the intervals R2, overlap each other. In either pattern, the recorded areas of the two colors are alternately repetitively arranged to have a total width R3. In the example of FIG. 4A, transparent toner recorded areas and black toner recorded areas are arranged to completely overlap each other. In the example of FIG. 4B, recorded area of the two colors are arranged not to overlap each other. In either pattern, the total width is R3. In these adjustment patterns, the width R1 is half the interval R2 and is, for example, 200 μm, and the total width R3 is, for example, 10 mm. For example, the adjustment pattern shown in FIG. 4B is obtained by alternately repeating 50 R1-wide transparent toner recorded areas and 50 R1-wide black toner recorded areas in the paper-feeding direction. The toner image of this adjustment pattern is formed within the measured area of the CCD image sensor 222 in order to measure it by the CCD image sensor 222.

Registration adjustment processing in the first embodiment uses a plurality of adjustment pattern data including the pattern data in FIG. 4A and that in FIG. 4B. More specifically, this processing adopts a plurality of adjustment pattern data obtained by changing stepwise the degree of overlapping between the transparent and black toners from 100% in the adjustment pattern data of FIG. 4A to 0% in the adjustment pattern data of FIG. 4B.

An outline of registration error amount calculation in the first embodiment using these adjustment pattern data will be explained. The measured density value of the toner image of the adjustment pattern as shown in FIGS. 4A and 4B changes depending on the amount of registration error between the transparent toner recorded area and the black toner recorded area. In the first embodiment, the density is measured while changing the number of overlapping pixels of the transparent and black toners stepwise from that of FIG. 4A to that of FIG. 4B. A change of the measured density value and a known number of overlapping pixels are compared to obtain the amount of registration error between the two colors. The number of overlapping pixels indicates the degree of overlapping between the transparent and black toners.

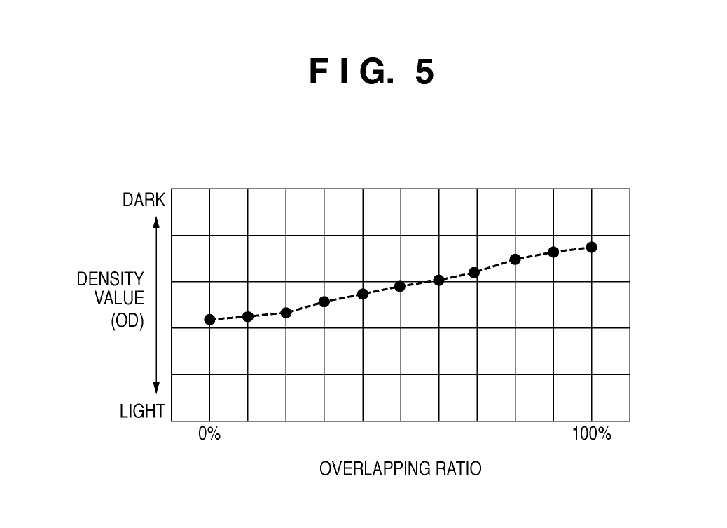

The principle of registration error amount calculation will be described with reference to FIG. 5. FIG. 5 is a graph showing a density characteristic obtained when forming a toner image on printing paper P while changing stepwise the number of overlapping pixels of adjustment pattern data from the pattern of FIG. 4A in which the ratio of the number of overlapping pixels of the two colors is 100%, to the pattern of FIG. 4B in which the ratio of the number of overlapping pixels is 0%. Referring to FIG. 5, the abscissa indicates the ratio between the numbers of overlapping pixels of the two colors (to be referred to as overlapping ratio), and the ordinate indicates the density value (OD value). Referring to FIG. 5, the density monotonically decreases from the pattern of FIG. 4A in which the overlapping ratio between the two colors is 100% to the pattern of FIG. 4B in which the overlapping ratio is 0%.

The correlation as shown in FIG. 5 is obtained for the following reason. That is, toner used in the electrophotographic method is a mixture of developer and colorant, and the volume of the colorant remaining on the paper surface is large. In particular, repetitively applying toner to the same portion by the electrophotographic method further increases the volume of the colorant remaining on the paper surface. A large colorant volume makes an increase in colorant area. Thus, the colorant area and density increase at a portion (portion comprising two or more color elements) where toners overlap each other by the electrophotographic method. For example, when the transparent and black toners overlap each other at the same portion, the area of the black toner having high contribution to the density increases, and thus the density increases.

In the first embodiment, therefore, a toner image is formed on printing paper P in accordance with adjustment pattern data in which the overlapping amount of the two colors is changed stepwise from the pattern data of FIG. 4A to that of FIG. 4B. Then, the density value of the toner image is measured. The amount of registration error generated between the two colors is obtained based on a change of the density value with respect to a known overlapping amount of the two colors.

Registration Adjustment Image Pattern Measurement Processing

The above-described registration adjustment image pattern measurement processing in step S302 will be described in detail. The toner images of adjustment patterns formed on the respective photosensitive drums 211 are sequentially transferred onto the intermediate transfer belt 221 and printing paper P, and the printing paper P is conveyed. The toner images of the adjustment patterns on the conveyed printing paper P are fixed by the fixing unit 223, and sequentially read by the CCD image sensor 222 having an optical system comprising an illumination lamp, condenser lens, and reflecting mirror (none of them is shown).

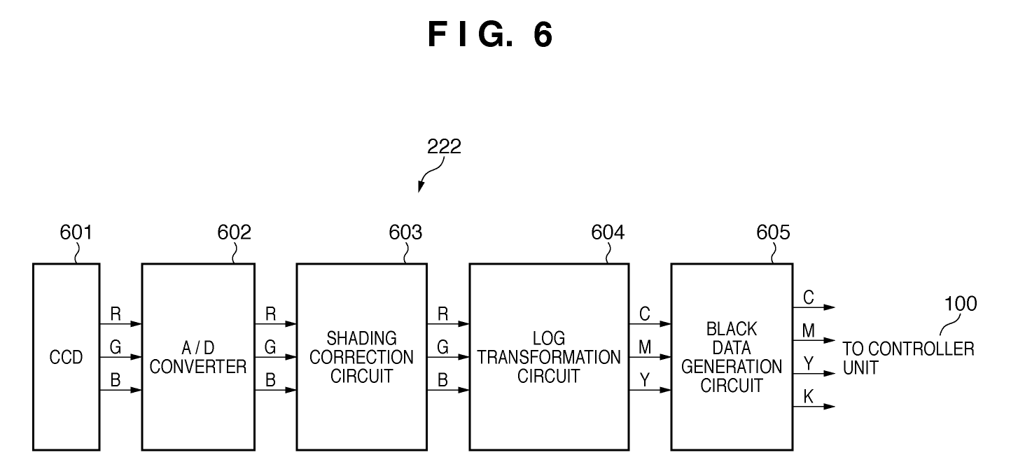

FIG. 6 shows the detailed arrangement of the CCD image sensor 222 in the first embodiment. The operation of the CCD image sensor 222 will be explained. In the CCD image sensor 222, first, a solid-state image sensing element (CCD) 601 converts a toner image into multi-valued analog signals. Then, an A/D converter 602 converts the obtained analog signals into digital R, G, and B signals corresponding to the luminance. A shading correction circuit 603 performs shading correction for the digital R, G, and B signals to correct variations of the optical system and CCD 601. A LOG transformation circuit 604 transforms the R, G, and B values serving as luminance data into density values of cyan (C), magenta (M), and yellow (Y) complementary colors corresponding to R, G, and B in accordance with equation (1):

C=−log₁₀R

M=−log₁₀G

Y=−log₁₀B (1)

A black data generation circuit 605 extracts a black (K) density value from the C, M, and Y density values obtained by equation (1). As an example of the K extraction method, K data is generated from minimum C, M, and Y values. Note that K data may be generated using, for example, an LUT (Look Up Table) which is prepared in advance and describes RGB luminance information and CMYK density information.

In the first embodiment, it suffices to use a common simple sensor as the CCD 601. For example, the reading resolution suffices to be low, and the aperture size suffices to be a four millimeter square corresponding to about 6 dpi. Further, the aperture size can be an integer multiple of the recording width R2 of the two colors shown in FIGS. 4A and 4B.

Such a sensor is used for the following reason. The sensor used in the first embodiment reads an adjustment pattern in which line-shaped recorded areas of the black and transparent toners are arranged as shown in FIGS. 4A and 4B. The average density value is acquired from toner images of the two colors within the aperture. If the number of lines within the aperture differs between the two colors, an error occurs in the read density value. To prevent this, in the first embodiment, the aperture size is set to an integer multiple of the recording width R2 of the two colors. As a result, the numbers of lines of the two colors within the aperture become equal to each other, and a plurality of lines fall within the aperture. This minimizes density variations caused by a measurement error. More specifically, for an aperture of a four millimeter square, 200-μm (width R1) black toner recorded areas and transparent toner recorded areas exist each for 10 lines within the aperture. In this case, even if an extra black or transparent toner recorded area exists as an error within the aperture in measurement, it is merely about several μm. For example, even if a 10-μm recorded area exists, density variations are merely 10/4000, that is, 0.25%. According to the density characteristic of the adjustment pattern shown in FIG. 5, for example, when the density value is defined as 1.0 for an overlapping pixel ratio of 100% between the two colors, the density value is about 0.8 for an overlapping pixel ratio of 0%. Even if the measurement error of ±0.25% is added to this density value, the density characteristic hardly changes.

In this manner, the CCD image sensor 222 of the first embodiment uses the CCD 601 having the above-mentioned aperture size to read density values from the toner images of the two colors in the adjustment pattern formed on printing paper P. The read density values are sent to the controller unit 100 and are used to obtain the registration error amount.

Registration Error Amount Calculation Processing

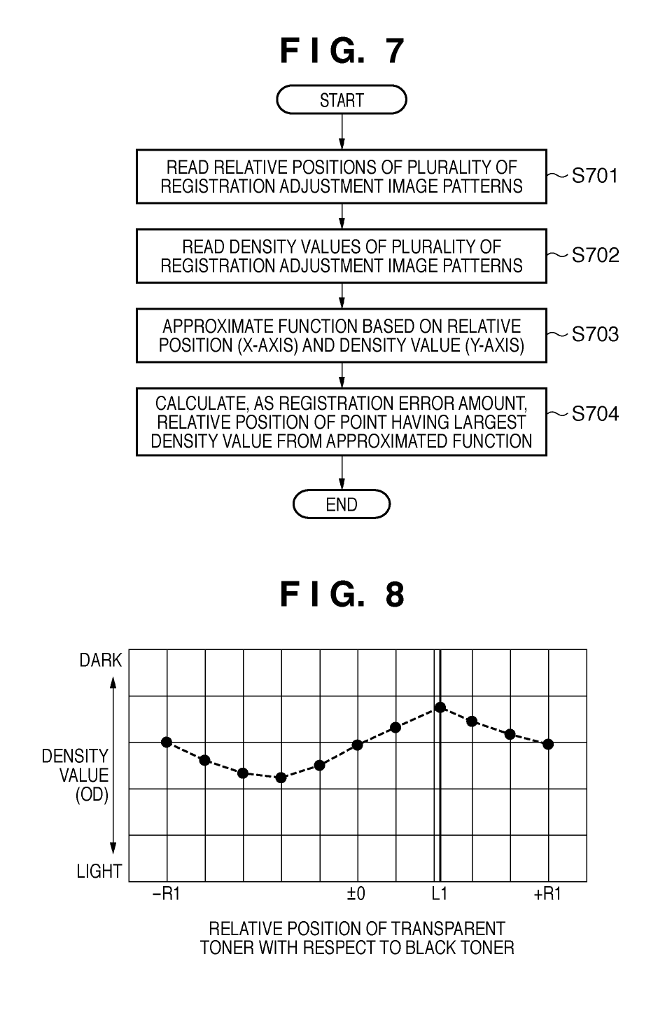

The above-described registration error amount calculation processing in step S303 will be explained in detail with reference to the flowchart of FIG. 7.

In step S701, a predetermined amount of registration error between the two colors, that is, a position of the transparent toner relative to the black toner is read for an image signal (to be referred to as adjustment pattern data) for forming a plurality of adjustment patterns mentioned above. As described above, a plurality of adjustment pattern data are obtained by changing stepwise the overlapping amount of the recorded areas of the transparent and black toners. The amount of overlapping between the two colors, that is, a position of the transparent toner relative to the black toner is set in advance.

A case in which 11 types of adjustment pattern data from the pattern of FIG. 4A to that of FIG. 4B are used as a plurality of adjustment pattern data obtained by changing stepwise the overlapping amount will be exemplified. In the 11 types of adjustment pattern data used, the overlapping pixel ratio indicating the amount of overlapping between the images of the recorded areas of the two colors changes from 100% to 0% in steps of 10%. In the 11 types of adjustment pattern data, when the output resolution is 2,400 dpi, R1 of the recorded areas of the transparent and black toners is 20 pixels (200 μm). The number of overlapping pixels in adjustment pattern data for an overlapping pixel ratio of 10% is 10% of 20 pixels of the recorded area, that is, two pixels (20 μm).

In the first embodiment, the image start position of the black toner shown in FIG. 4A is set as a reference, and the image start position of the transparent toner with respect to the reference position is acquired as the relative position between the two colors. For example, in the adjustment pattern data of FIG. 4A, the overlapping pixel ratio between the black and transparent toners is 100%, so the relative position between the two colors in the adjustment pattern data is 0.

In step S701, positions of the transparent toner relative to the black toner, which are set in advance for respective adjustment pattern data for registration adjustment, are sequentially read. Note that the relative position between the two colors may be a preset value in accordance with the recording order of adjustment pattern data.

In step S702, density values sequentially read in step S302 by the CCD image sensor 222 are loaded for the toner images of a plurality of adjustment patterns formed on the printing paper P. In this case, density values are acquired from adjustment patterns (10 millimeter square) each having one of 11 overlapping pixel ratios between the recorded areas of the two colors, as described above.

The density value of the adjustment pattern that is detected in the first embodiment will be described in detail. In the first embodiment, for each adjustment pattern, a value which is equal to or larger than a predetermined threshold is detected as the density value of the adjustment pattern out of density values for a four millimeter square that are sequentially read by the CCD image sensor 222 in the paper-feeding direction. It suffices to set the detection density threshold as follows. For example, the density value of an image formed in the two colors becomes larger than that of an image formed with the single black toner, as described above. As the detection density threshold, therefore, it suffices to set in advance a value which is larger than the density value of an unrecorded area on the paper surface and smaller than that of the recorded area of the single black toner.

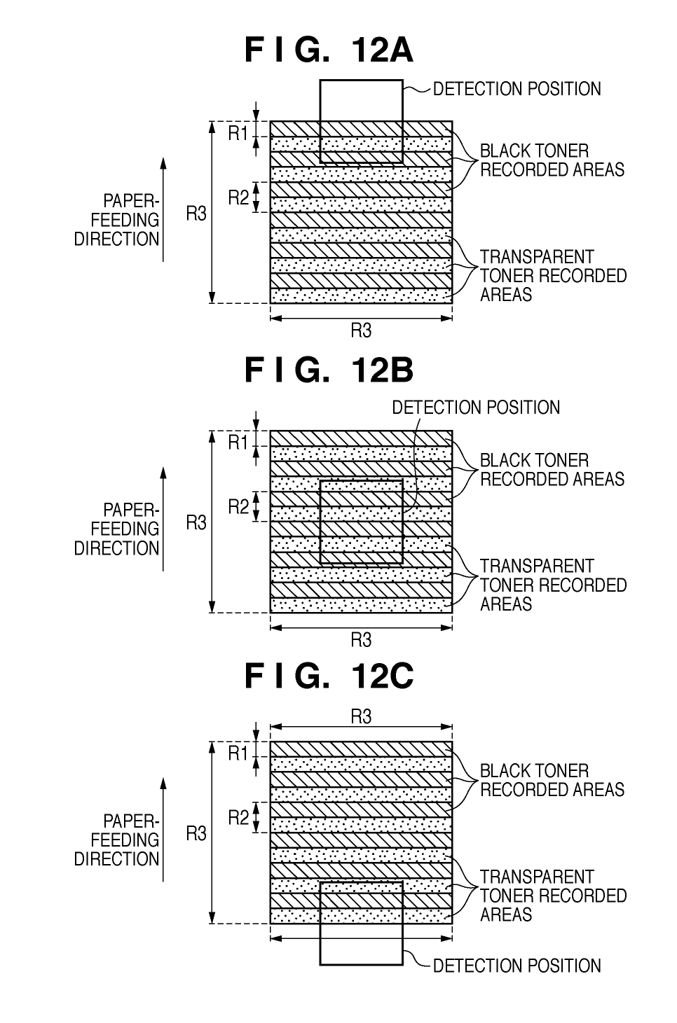

The relationship between the detection position on the adjustment pattern by the CCD image sensor 222, and the density value in the first embodiment will be explained in detail with reference to FIGS. 12A to 12C. The adjustment pattern on printing paper P is conveyed in the order of FIGS. 12A, 12B, and 12C, and read by the CCD image sensor 222. In the states of FIGS. 12A and 12C, the detection position contains both part of the adjustment pattern and the paper surface of an unrecorded area, and a detected density value becomes smaller than the density value of an adjustment pattern formed with the single black toner. To the contrary, in the state of FIG. 12B, the detection position is a four millimeter square within the adjustment pattern (with a 10 millimeter square), and a density value equal to or larger than the threshold is detected. From this, the threshold is set to be larger than the density value of an unrecorded area on the paper surface and smaller than the density value of the single black toner, as described above. Only when at least part of the adjustment pattern falls within the aperture of the CCD 601, the density value is detected. Especially when the detection position falls within the adjustment pattern, like FIG. 12B, the density value may be measured. For example, the density value can be continuously measured while conveying printing paper. In this case, when the detection position falls within the adjustment pattern, as shown in FIG. 12B, the density value is considered to take a maximum or minimum value. The maximum or minimum value among detected density values can be set as the density value of the adjustment pattern during measurement.

In step S703, a curve indicating the relationship between the relative position between the two colors in the adjustment pattern data that has been acquired in step S701, and the density value of the adjustment pattern that has been acquired in step S702 is approximated to a function. FIG. 8 shows the relationship between the relative position between the two colors, and the density value that has been obtained in step S703. In FIG. 8, the abscissa indicates the relative position misalignment amount, and the ordinate indicates the density value (OD value). Note that the function approximation method in the first embodiment suffices to be a known method such as spline interpolation or linear interpolation between points.

In step S704, the relative position between the two colors at a point having a largest density value is obtained from the function obtained in step S703, and acquired as a registration error amount L1 between the two colors. A point having a largest density value corresponds to a state in which the overlapping pixel ratio between the transparent and black toners on the printing paper P is 100%. In this state, the overlapping pixel ratio between the transparent and black toners on the printing paper P is 100%, including the amount of registration error between the two colors. That is, the amount of registration error between the two colors using the black toner write position as a reference is L1. In step S703, a curve indicating the relationship between the relative position between the two colors in the adjustment pattern data that has been acquired in step S701, and the density value of the adjustment pattern that has been acquired in step S702 is approximated by a function. However, the curve need not be approximated if a point having a highest density can be obtained without approximation.

In the first embodiment, the registration error between the image forming units 210 is corrected by adjusting the image write timings of the image forming units 210 in step S304 based on the amount L1 of registration error between the two colors that has been calculated in the above fashion.

As described above, according to the first embodiment, the misalignment amount can be easily detected by forming a plurality of adjustment patterns for registration adjustment in which the density value changes depending on the amount of misalignment between the recorded positions of the transparent and black toners. By measuring the density values of these patterns, the amount of registration error between the two colors can be obtained. The registration error between the two colors can be corrected by changing the scan timing of the laser scanner based on the registration error amount. The first embodiment has mainly described a method of correcting a registration error between a colored colorant, particularly the black toner, and the transparent toner. However, the method of the first embodiment can also be used to correct a registration error between two arbitrary, different colorants. For example, the density value is considered to change depending on the degree of overlapping between two colored colorants. To correct a registration error between two colored colorants, the method of the first embodiment can be applied.

### Second Embodiment

The second embodiment according to the present invention will be described. The first embodiment has described an example in which a plurality of adjustment patterns in which the density value changes depending on the amount of registration error between two colors are formed, and their density values are measured to obtain the amount of registration error between the two colors. The second embodiment will describe an example in which the amount of registration error between two colors is obtained from one adjustment pattern. Note that the arrangement of an image forming apparatus in the second embodiment is the same as that in the first embodiment, and a detailed description thereof will not be repeated.

Registration Adjustment Image Pattern Output Processing

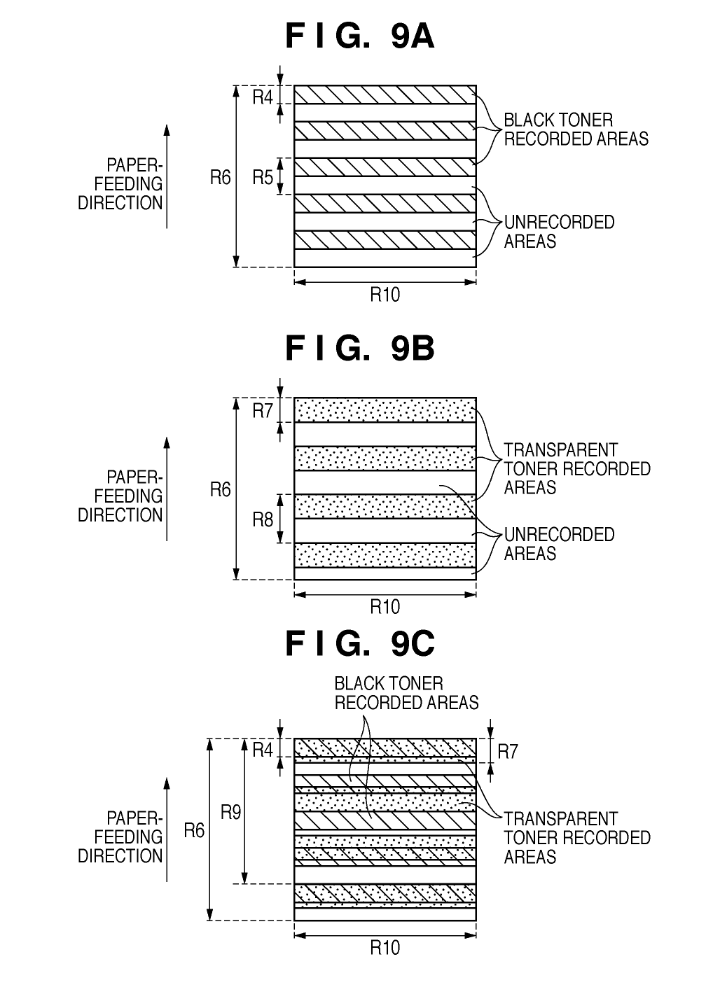

An adjustment pattern output in the second embodiment will be exemplified with reference to FIGS. 9A to 9C. FIG. 9A shows a pattern recorded with only the black toner, and FIG. 9B shows a pattern recorded with only the transparent toner. In the pattern of FIG. 9A, the size of the black toner recorded area is R10 in a direction perpendicular to the paper-feeding direction, and R4 in the paper-feeding direction. Recorded and unrecorded areas are alternately arranged at first intervals R5 in the paper-feeding direction, and the total size in the paper-feeding direction is R6. In the pattern of FIG. 9B, the size of the transparent toner recorded area is R10 in a direction perpendicular to the paper-feeding direction, and R7 in the paper-feeding direction. Recorded and unrecorded areas are alternately arranged at second intervals R8 in the paper-feeding direction, and the total size in the paper-feeding direction is R6. The width R4 is half the interval R5, and the width R7 is half the interval R8. The adjustment patterns shown in FIGS. 9A to 9C will be explained in more detail. When the output resolution of the image forming apparatus is, for example, 2,400 dpi, black toner recorded areas form a screen image having 50 screen lines/inch, and transparent toner recorded areas form a screen image having 48 screen lines/inch. The intervals (numbers of pixels) R5 and R8 are obtained by dividing the output resolution by these numbers of screen lines. In this case, R5 is 48 pixels (about 500 μm), and R8 is 50 pixels (about 530 μm).

FIG. 9C shows an image patch actually used in the second embodiment. This image patch is a pattern of the two colors formed by superposing the pattern of FIG. 9A and that of FIG. 9B. In this adjustment pattern, transparent toner recorded areas and black toner recorded areas periodically overlap each other, and an interference occurs between the two colors (dot gain). The interference increases the density in the overlapping area. FIG. 9C shows an example in which the interference between the two colors occurs in a cycle R9. The interference cycle R9 between the two colors is obtained from the difference between the cycles of the respective colors. In FIG. 9C, the difference between the 50 screen lines and the 48 screen lines is two, so the interference cycle R9 is 1,200 pixels (about 13 mm).

In the second embodiment, the registration error amount is obtained from the density value difference arising from the interference between the two colors. Hence, at least one interference cycle between the two colors is required in the adjustment pattern used for registration adjustment. For this purpose, the size R6 of the whole adjustment pattern in the paper-feeding direction in the second embodiment suffices to be larger than the interference cycle R9, and for example, be 15 mm.

In the second embodiment, the amount of recorded position misalignment between the two colors is calculated using adjustment patterns as shown in FIGS. 9A to 9C. More specifically, the amount of registration error generated between the two colors is obtained by comparing a known density value acquired in advance for adjustment pattern data with a density value acquired from the toner image of an adjustment pattern formed on printing paper P.

Registration Error Amount Calculation Processing

Registration error amount calculation processing in the second embodiment will be explained in detail with reference to the flowchart of FIG. 11.

In step S1101, the first density distribution serving as a theoretical value is acquired for adjustment pattern data. The adjustment pattern data in the second embodiment is overlapping data of the two colors, and the first density distribution is a density distribution in a state in which no registration error is generated between the two colors. The first density distribution is formed from intra-pattern positions each indicating a recorded position in the adjustment pattern, and the density values of the intra-pattern positions. In the second embodiment, a RAM 104 holds data calculated in advance as the first density distribution. As the first density distribution calculation method, for example, the rectangular wave of a black toner image signal value and that of a transparent toner image signal value are composited. Note that the image signal value may be approximated by a sine wave, instead of the rectangular wave. Regarding the first density distribution, the rectangular wave may undergo processing such as a convolution processing using a low-pass filter in consideration of the development characteristic, unless the density relationship does not change. The second embodiment may adopt a convolution processing to the image signals of the two colors using a low-pass filter in consideration of the development characteristic, in order to obtain the first density distribution. The first density distribution may be created in advance by checking the relationship between overlapping of the toners and the density value for an actually formed adjustment pattern.

In step S1102, a density value read in step S302 by a CCD image sensor 222 from the toner image of the adjustment pattern formed on the printing paper P is acquired. In this case, intra-pattern positions and density values at a plurality of measurement points are acquired from the adjustment pattern in the second embodiment as shown in FIG. 9C. In the second embodiment, the density value of the adjustment pattern periodically changes owing to the interference between the two colors. Thus, the aperture size of a CCD 601 suffices to be smaller than one cycle of the interference between the two colors. At this time, at least two measurement points are necessary in the cycle of the interference between the two colors to measure the density value of the adjustment pattern. A larger number of measurement points increase the registration error amount calculation precision. In the following description, the aperture size of the CCD 601 is a four millimeter square, the interval between measurement points is 200 pixels, six measurement points are set in the cycle of the interference between the two colors, and the interference cycle R9 between the two colors is 13 mm (1,200 pixels).

The toner image of the adjustment pattern is measured at the interval between the measurement points, and the CCD image sensor 222 outputs density values corresponding to the respective measurement points. The acquired intra-pattern positions and density values of the measurement points form the second density distribution. The second density distribution is obtained from an actually formed image patch, and is a density distribution containing the registration error between the two colors. As the adjustment pattern measurement method, the same method as that in the first embodiment is applicable. The intra-pattern position of a measurement point where the density value first becomes equal to or larger than a predetermined value is defined as 0, and intra-pattern positions and density values are acquired sequentially from the position “0” with intervals between measurement points.

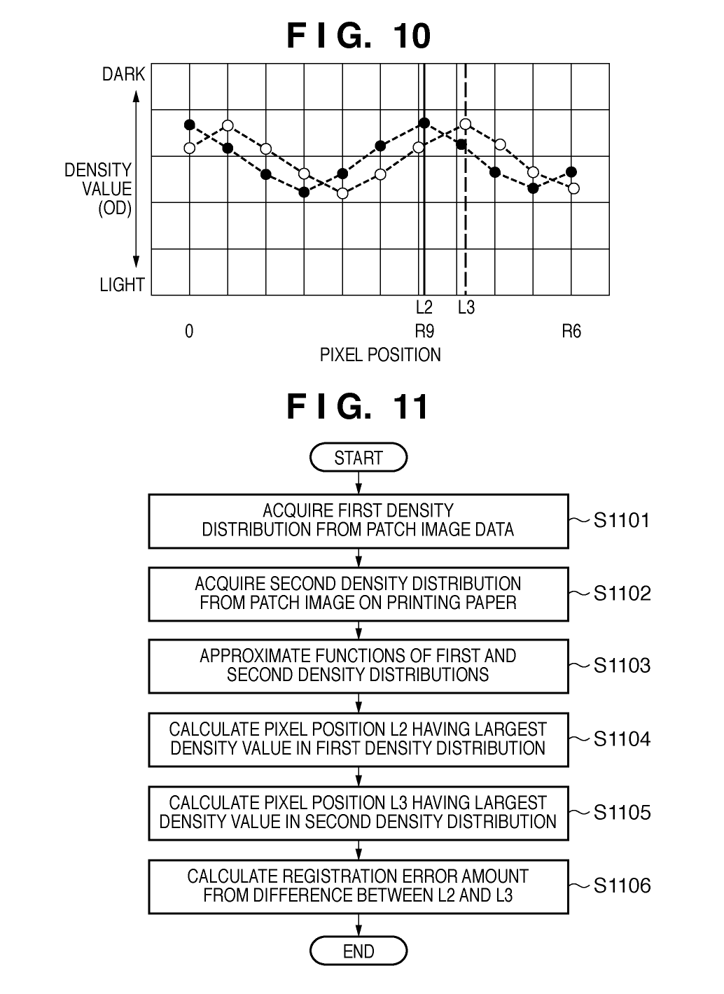

In step S1103, a curve corresponding to the intra-pattern positions and the density values is approximated to a function based on the first and second density distributions obtained in steps S1101 and S1102. Note that the function approximation method is the same as that in the first embodiment. FIG. 10 is a graph showing the first and second density distributions approximated to functions in step S1103. Referring to FIG. 10, the abscissa indicates the intra-pattern position, and the ordinate indicates the density value (OD value). The intra-pattern position “0” is the first recorded position of the adjustment pattern, and R6 is the final recorded position of the adjustment pattern. R9 is a recorded position having the highest density in the first density distribution acquired in step S1101. Closed circles indicate intra-pattern positions and density values in the first density distribution, and open circles indicate intra-pattern positions and density values in the second density distribution.

In step S1104, the intra-pattern position L2 of a point having a largest density value is obtained from the approximated curve of the first density distribution that has been obtained in step S1103. The intra-pattern position L2 is a point where the transparent and black toners overlap each other without a registration error, as described above.

In step S1105, the intra-pattern position L3 of a point having a largest density value is obtained from the approximated curve of the second density distribution that has been obtained in step S1103. Similar to step S1104, the intra-pattern position L3 is a point where the transparent and black toners overlap each other when a registration error is generated between the two colors, as described above.

In step S1106, the difference between L2 and L3 obtained in steps S1104 and S1105 is obtained and calculated as a registration error amount. At this time, the intra-pattern positions L2 and L3 indicate recorded positions when a registration error is not generated and is generated, respectively. By comparing the intra-pattern positions L2 and L3 to obtain the difference, the amount of registration error between the two colors can be calculated. For example, no difference between L2 and L3 means that no registration error occurs between the two colors.

As described above, according to the second embodiment, the registration error amount can be obtained by forming an adjustment pattern in which transparent toner recorded areas and black toner recorded areas are formed at different intervals, and comparing a density change based on the cycle of the interference between the two colors when a registration error is generated, with one when no registration error is generated. The registration error between the two colors can be corrected by changing the scan timing of the laser scanner based on the registration error amount.

In the first and second embodiments described above, a point having a largest density value in the density distribution is used to determine the amount of registration error between the two colors. To the contrary, a point having a smallest density value can be used to determine the registration error amount. It is also possible to compare registration error amounts at a point having a largest density value and ones at a point having a smallest density value, and determine a larger registration error amount in accordance with the comparison result.

In the above embodiments, the registration error amount is detected from the toner image of an adjustment pattern formed on a printing medium. Instead, the toner image of the adjustment pattern formed on the intermediate transfer belt may be used. In this case, it suffices to arrange the CCD image sensor 222 on the downstream side of the image forming unit 210 on the intermediate transfer belt 221 and detect the toner image of the adjustment pattern.

The sensor is not limited to the CCD image sensor incorporated in the image forming apparatus. For example, an image scanner outside the image forming apparatus may be used to detect the toner image of an adjustment pattern formed on printing paper and obtain the registration error amount.

### Third Embodiment

The third embodiment according to the present invention will be described. In the first and second embodiments, one or a plurality of registration adjustment patterns in which the density value changes depending on the amount of registration error between two colors are formed, and their density values are measured to adjust the amount of registration error between the two colors. The third embodiment will describe an example in which not only the amount of registration error between two colors but also those between the transparent, C, M, Y, and K toners are adjusted. Note that the arrangement of an image forming apparatus and registration adjustment processing in the third embodiment are the same as those in the first or second embodiment, and a detailed description thereof will not be repeated.

The amounts of registration errors between the transparent, C, M, Y, and K toners can be adjusted using a combination of the conventional registration adjustment processing described above and the first or second embodiment.

First, the conventional registration adjustment processing is executed as shown in FIG. 13, obtaining the registration error amounts of the four, C, M, Y, and K colors using black as a reference color. As described above, a registration adjustment pattern 1301 in which the recorded areas of the respective colors are arranged at known intervals is formed on an intermediate transfer belt 221. A density sensor 225 detects the recorded positions of the respective colors, obtaining the registration error amounts of the respective colors with respect to the black reference color.

Then, the registration adjustment processing explained in the first or second embodiment is performed, obtaining the registration error amount of the transparent toner with respect to the black reference color. As a result, the registration error amounts of the transparent toner, and C, M, and Y color toners with respect to the black reference color can be attained.

The registration errors between the transparent, C, M, Y, and K toners can be corrected by changing the scan timings of the laser scanners of the respective colors based on registration error amounts with respect to the reference color.

The amounts of registration errors between the C, M, Y, and K toners can also be obtained using the method described in the first or second embodiment, instead of the method shown in FIG. 13. For example, the registration error amount can be obtained using the method described in the first or second embodiment for a combination of two colors out of C and K, M and K, Y and K, and transparent toner and K. In this fashion, the amounts of registration errors between the C, M, Y, and transparent toners and the K toner can be attained. By correcting registration errors in accordance with the obtained registration error amounts, the registration errors between the C, M, Y, K, and transparent toners can be corrected.

In the first, second, and third embodiments, black is used as the reference color in registration adjustment. However, the reference color is not limited to black, and the same effects as those described above can be obtained even using another color as the reference color.

### Fourth Embodiment

In the above embodiments, measurement points are approximated to a function along an interpolation curve or the like. However, a registration error may be determined using a measurement point having a largest or smallest density value without approximation. For example, the overlapping pixel ratio between two colors is 0% or almost 0% at a point having a smallest density value. Thus, the registration error amount can be obtained using the relative position between two colors set in advance in adjustment pattern data, and the difference of the image recording width R1.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-010368, filed Jan. 20, 2010 and No. 2010-236846, filed Oct. 21, 2010, which are hereby incorporated by reference herein in their entirety.

What is claimed is:

1. An image forming apparatus which forms an output image using a transparent colorant and a colored colorant, the apparatus comprising:
a formation unit configured to form an adjustment pattern image using the transparent colorant and the colored colorant;
an acquisition unit configured to acquire a density value in the formed pattern image; and
a calculation unit configured to calculate, based on the acquired density value, a misalignment amount of the transparent colorant with respect to the colored colorant,
wherein in the formed pattern image, the area with the transparent colorant are repetitively arranged at first intervals, and the area with the colored colorant are repetitively arranged at second intervals.

2. The apparatus according to claim 1, wherein the first interval and the second interval are equal, and wherein the pattern image comprises a plurality of images with different overlapping amount between the area with the transparent colorant and the area with the colored colorant.

3. The apparatus according to claim 2, wherein said calculation unit is further configured to determine the overlapping amount in an image with a largest density value among a plurality of images comprising the pattern image, which density value is acquired by said acquisition unit, to be the misalignment amount.

4. The apparatus according to claim 1, wherein the first interval and the second interval are different.

5. The apparatus according to claim 4, wherein:
said acquisition unit is further configured to acquire intra-pattern positions and density values at a plurality of measurement points in the pattern image, and
said calculation unit is further configured to acquire a first density distribution based on an image signal used by said formation unit to form the pattern image, acquire a second density distribution based on density values acquired by said acquisition unit, and calculate, as the misalignment amount, a difference of intra-pattern positions each having a largest or a smallest density value between the first density distribution and the second density distribution.

6. The apparatus according to claim 1, wherein the transparent colorant and the colored colorant are toners.

7. The apparatus according to claim 1, wherein said formation unit is further configured to form the pattern image on a printing medium.

8. The apparatus according to claim 1, further comprising a record position adjustment unit configured to adjust, based on the misalignment amount calculated by said calculation unit, recording position of the transparent colorant with respect to the recording position of the colored colorant.

9. An image forming apparatus which forms an output image using a transparent colorant and a colored colorant, the apparatus comprising:
an input unit configured to input a pattern image for adjusting misalignment of a recorded position of a colorant; and
a formation unit configured to form the pattern image using the transparent colorant and the colored colorant,
wherein in the formed pattern image, the area with the transparent colorant are repetitively arranged at first intervals, and the area with the colored colorant are repetitively arranged at second intervals.

10. A control method of an image forming apparatus which forms an output image using a transparent colorant and a colored colorant, the method comprising the steps of:
forming an adjustment pattern image using the transparent colorant and the colored colorant;
acquiring a density value in the formed pattern image; and
calculating, based on the acquired density value, a misalignment amount of the transparent colorant with respect to the colored colorant,
wherein in the formed pattern image, the area with the transparent colorant are repetitively arranged at first intervals, and the area with the colored colorant are repetitively arranged at second intervals.

11. A control method of an image forming apparatus which forms an output image using a transparent colorant and a colored colorant, the method comprising the steps of:
inputting a pattern image for adjusting misalignment of a recorded position of a colorant; and
forming the pattern image using the transparent colorant and the colored colorant,
wherein in the formed pattern image, the area with the transparent colorant are repetitively arranged at first intervals, and the area with the colored colorant are repetitively arranged at second intervals.

12. A storage medium storing a program which is executed by a computer to cause the computer to function as units of an image forming apparatus defined in claim 1.

13. A storage medium storing a program which is executed by a computer to cause the computer to function as units of an image forming apparatus defined in claim 9.
